(19) United States
(12) Patent Application Publication
(10) Pub. No.: US 2024/0114125 A1
(43) Pub. Date: Apr. 4, 2024

(54) METHODS AND APPARATUS FOR ASSESSING SENSOR ASSEMBLIES FOR AUTONOMOUS VEHICLES

(71) Applicant: Nuro, Inc., Mountain View, CA (US)

(72) Inventors: Fan Yang, Sunnyvale, CA (US); Samuel Cheng, San Jose, CA (US); Yun Zhang, San Jose, CA (US); Brian Hufnagel, Mountain View, CA (US); Tarik Snyder, Mountain View, CA (US); Jordan Aaron, Mountain View, CA (US); Biyu Ye, Mountain View, CA (US)

(73) Assignee: Nuro, Inc., Mountain View, CA (US)

(21) Appl. No.: 18/470,737

(22) Filed: Sep. 20, 2023

Related U.S. Application Data
(60) Provisional application No. 63/412,160, filed on Sep. 30, 2022.

(51) Int. Cl. H04N 17/00; G01H 17/00; G01S 7/497; G06T 7/80; H04N 23/51; H04N 23/56; H04N 23/90; H04R 29/00

(52) U.S. Cl. CPC H04N 17/002; G01H 17/00; G01S 7/497; G06T 7/80; H04N 23/51; H04N 23/56; H04N 23/90; H04R 29/004

(57) ABSTRACT

According to one aspect, a method includes obtaining a sensor assembly that includes at least a first camera and a second camera, and positioning the sensor assembly in an enclosure of a sensor testing system. The enclosure has a first enclosure target and a second enclosure target affixed thereon, and includes a sensor arrangement. The sensor testing assembly further includes a computing arrangement and a data acquisition arrangement, The method also includes performing a first test on the sensor assembly by providing commands to the sensor assembly using the computing arrangement, and monitoring the sensor assembly during the first test. Monitoring the sensor assembly includes obtaining data from the sensor assembly and/or the sensor arrangement, and providing the data to the data acquisition arrangement. Finally, the method includes processing the data, wherein processing the data includes determining whether the data indicates that the sensor assembly passes the first test.

### CROSS REFERENCE TO RELATED APPLICATION

This application claims priority to U.S. Provisional Application No. 63/412,160, filed on Sep. 30, 2022, and entitled “METHODS AND APPARATUS FOR TESTING SENSOR ASSEMBLIES FOR AUTONOMOUS VEHICLES,” the contents of which are incorporated herein by reference in their entirety.

### TECHNICAL FIELD

The disclosure relates to providing systems for testing the performance of sensors. More particularly, the disclosure relates to a system which is suitable for use in testing the operation of sensors intended for use in an autonomous vehicle.

### BACKGROUND

Autonomous systems, e.g., autonomous vehicles and robotic systems, utilize sensors to perceive a surrounding environment. The ability to accurately perceive a surrounding environment is critical to the safe operation of an autonomous system. Integrated packages which include multiple sensors may provide coverage that improves the ability for an autonomous vehicle to operate safely. Such integrated packages may be relatively complex, and the ability to test such integrated packages is essential to ensure that the sensors included in the integrated packages are capable of operating properly.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a diagrammatic representation of a sensor assembly, e.g., sensor assembly 104 of FIG. 2, in accordance with an embodiment.

FIG. 4B is a block diagram representation of a sensor assembly, e.g., sensor assembly 104 of FIGS. 2 and 4A, in accordance with an embodiment.

FIG. 5 is a block diagram representation of a sensor testing system in accordance with an embodiment.

FIG. 6 is a process flow diagram which illustrates a method of using a sensor testing system to test a sensor assembly in accordance with an embodiment.

FIGS. 7A and 7B are a process flow diagram which illustrates a method of performing camera tests, e.g., step 629 of FIG. 6, in accordance with an embodiment.

FIG. 8A is a diagrammatic top-down representation of an enclosure of a sensor testing system with a sensor assembly positioned therein in accordance with an embodiment,

FIG. 8B is a diagrammatic top-down representation of an enclosure of a testing system with a sensor assembly positioned therein, e.g., enclosure 860a and sensor assembly 804 of FIG. 8A, which illustrates camera fields of view in accordance with an embodiment.

FIG. 8C is a diagrammatic top-down representation of a camera and a light arrangement, e.g., camera 846i and light arrangement 868 of FIGS. 8A and 8B in accordance with an embodiment.

FIG. 8D is a diagrammatic side-view representation of an enclosure of a testing system with a sensor assembly positioned therein, e.g., enclosure 860a and sensor assembly 804 of FIGS. 8A and 8B, which illustrates camera fields of view in accordance with an embodiment.

FIG. 9 is a process flow diagram which illustrates a method of monitoring testing performed on a sensor assembly using a sensor testing system in accordance with an embodiment.

FIG. 10 is a process flow diagram which illustrates a method of identifying a vehicle that includes a sensor assembly tested using a sensor testing system as being ready for use in accordance with an embodiment.

### DESCRIPTION OF EXAMPLE EMBODIMENTS

### General Overview

In one embodiment, a method includes obtaining a sensor assembly that includes at least a first camera and a second camera, and positioning the sensor assembly in an enclosure of a sensor testing system, the enclosure having a plurality of enclosure targets affixed thereon, the plurality of enclosure targets including a first enclosure target and a second enclosure target, wherein the enclosure includes a sensor arrangement. The sensor testing assembly further includes a computing arrangement and a data acquisition arrangement, The method also includes performing a first test on the sensor assembly, wherein performing the first test on the sensor assembly include providing commands to the sensor assembly using the computing arrangement, and monitoring the sensor assembly during the first test. Monitoring the sensor assembly includes obtaining data from at least one selected from a group including the sensor assembly and the sensor arrangement and providing the data to the data acquisition arrangement. Finally, the method includes processing the data, wherein processing the data includes determining whether the data indicates that the sensor assembly passes the first test.

According to another embodiment, an apparatus includes an enclosure arrangement, a computing arrangement, a data acquisition arrangement, and a power arrangement. The enclosure arrangement includes transparent enclosure surfaces, enclosure targets affixed to the transparent enclosure surfaces, a sensor arrangement, and a sensor assembly support arrangement. The sensor arrangement is configured to obtain information within the enclosure and the sensor assembly support arrangement is configured to support a sensor assembly. The computing arrangement is configured to communicate with the sensor assembly support arrangement, and the data acquisition arrangement configured to obtain data from the computing arrangement when the computing arrangement communicates with the sensor assembly support arrangement and to obtain data from the sensor arrangement. The power arrangement is configured to provide power to the sensor assembly support arrangement.

According to yet another embodiment, logic is encoded in one or more tangible non-transitory, computer-readable media for execution. When executed, the logic is operable to perform a first test on a sensor assembly positioned within an enclosure included in a sensor testing system. The sensor assembly includes at least a first camera and a second camera, and the sensor testing system further includes a sensor arrangement positioned in the enclosure. The enclosure has a first enclosure target and a second enclosure target affixed thereon. The logic operable to perform the first test on the sensor assembly includes logic operable to provide commands to the sensor assembly using the computing arrangement. The logic is also operable to monitor the sensor assembly during the first test, wherein the logic operable to monitor the sensor assembly includes logic operable to obtain data from at least one selected from a group including the sensor assembly and the sensor arrangement. Finally, the logic is operable to process the data, wherein the logic operable to process the data includes logic operable to determine whether the data indicates that the sensor assembly passes the first test.

An apparatus that is suitable for testing a sensor assembly may include an enclosure the effectively contains, e.g., substantially houses, the sensor assembly while the sensor assembly is tested. A test enclosure may include one or more transparent enclosure walls to facilitate testing of cameras and/or lidars that are part of the sensor assembly. Targets such as camera targets may be affixed to the test enclosure, and a light source and collimator of the apparatus may be positioned within the test enclosure, The light source and the collimator may be used to verify that each cameras included in the sensor assembly, as well as other components, e.g., a rotatable sensor window associated with the cameras, are functioning as expected. Other targets, as for example lidar targets, may be provided outside the test enclosure to ensure that one or more lidar included in the sensor assembly are functioning as expected. An automated or semi-automated process may be performed to ensure that the sensors of the sensor assembly are able to function as expected.

### DESCRIPTION

Autonomous vehicles generally include multiple sensors that are configured to collect data relating to surrounding environments of the autonomous vehicles. The collected data is typically used by an autonomous vehicle to effectively perceive the environment around the autonomous vehicle. The ability to accurately perceive the environment around an autonomous vehicle is critical, as an inaccurate perception may lead to an inability for an autonomy system of a vehicle to enable the vehicle to safely operate autonomously. That is, if sensors of a vehicle which are associated with a perception system are not able to operate at a desired or otherwise require level of accuracy, the ability of an autonomy system to enable the vehicle to operate autonomously may be compromised.

By testing sensors or otherwise verifying the accuracy of sensors prior to installing the sensors on a vehicle, the ability of the sensors to function as expected may be determined and mitigating steps may be taken prior to the sensors being installed. For example, if sensors do not meet specified metrics, the sensors may be replaced or may be fine-tuned, as appropriate. In one embodiment, a sensor assembly that includes multiple sensors may be tested or otherwise verified using a testing assembly that includes an enclosure and one or more targets. The enclosure enables certain testing characteristics of a sensor assembly to be substantially isolated and, as a result, measured relatively accurately.

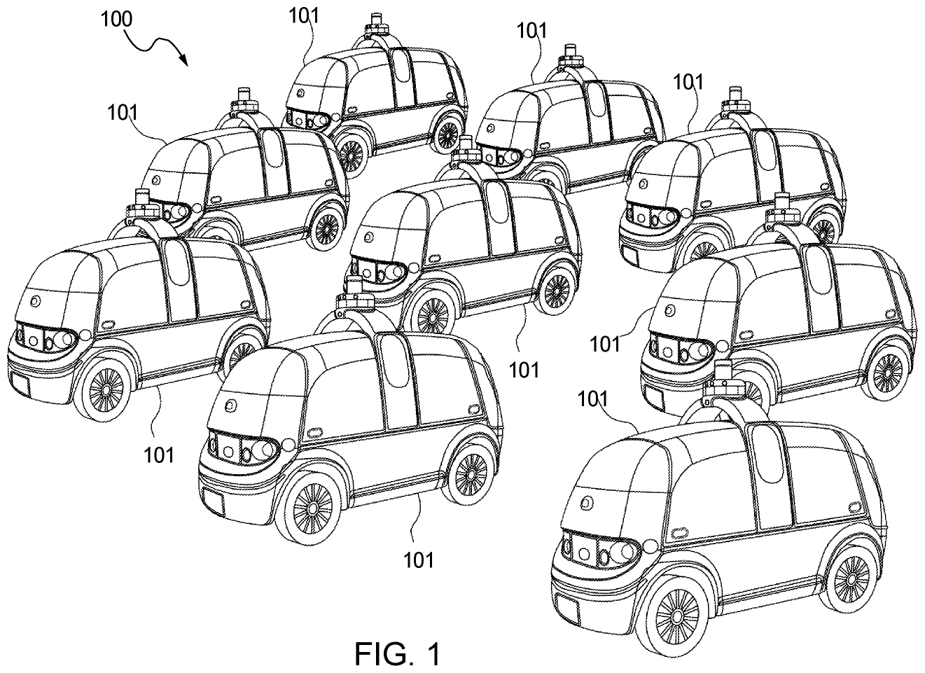

Sensor assemblies, or assemblies that include one or more sensors, may be installed on autonomous vehicles that are part of a fleet of autonomous vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

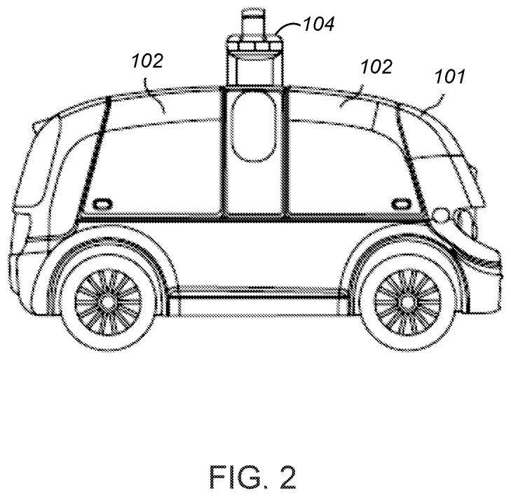

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102 and a sensor assembly 104. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

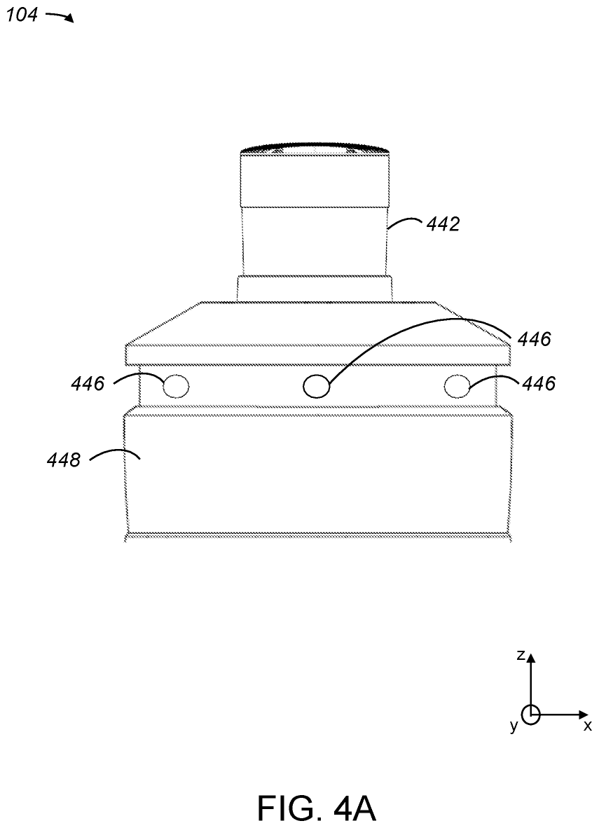

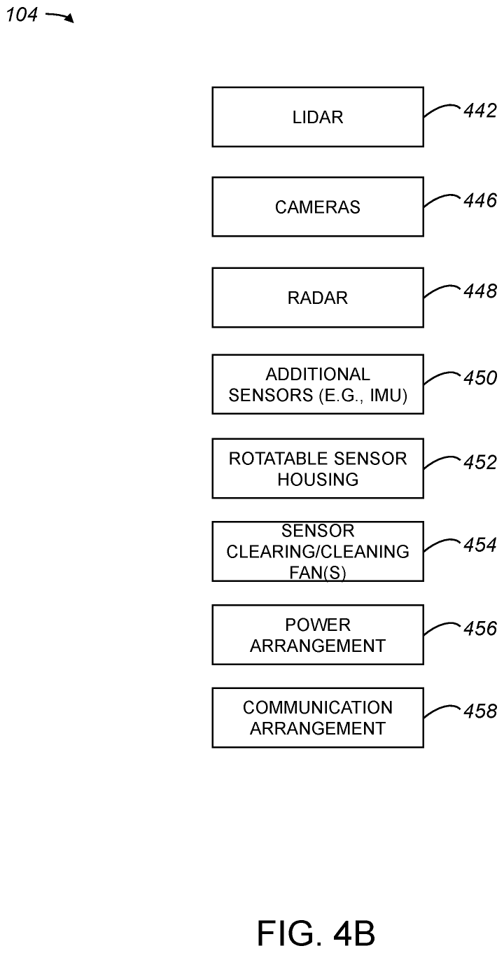

Sensor assembly 104 may include any suitable sensors, and any number of sensors. In one embodiment, sensor assembly 104 includes one or more cameras, one or more lidars, and one or more radars. One embodiment of sensor assembly 104 will be discussed below with reference to FIGS. 4A and 4B.

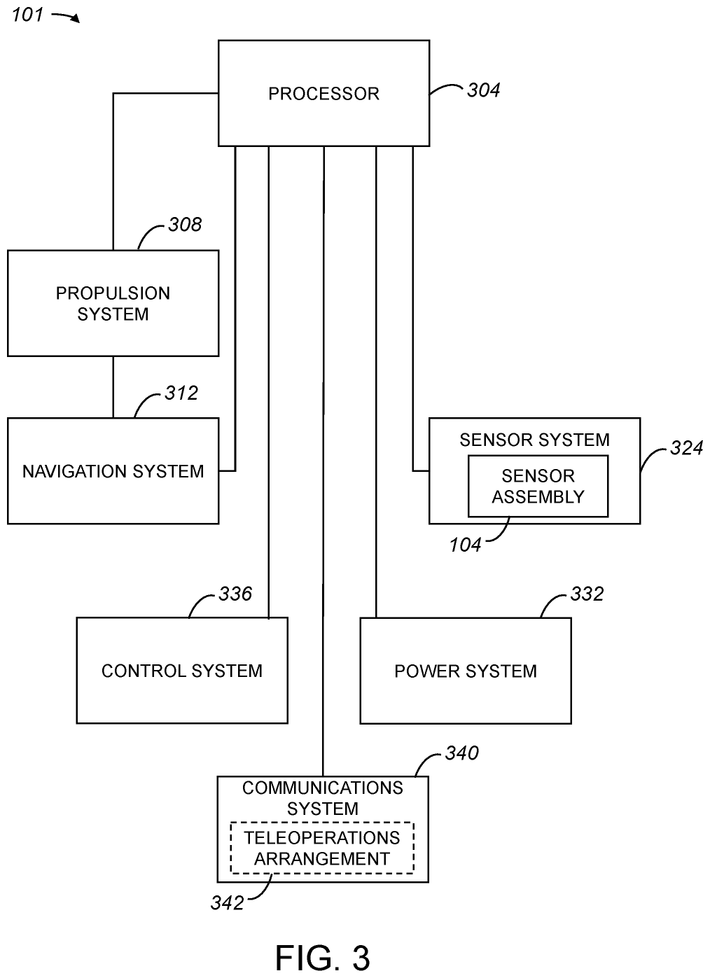

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101. In one embodiment, sensor system includes sensor assembly 104, as shown in FIG. 2, which includes sensors capable of collecting data that may be used by a perception system. Sensor assembly 104 may be positioned atop vehicle 101 such that a substantially 360 degree view of an environment surrounding vehicle 101 may effectively be captured. It should be appreciated, however, that sensor assembly 104 may generally be positioned substantially anywhere onboard vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand. In one embodiment, communication system 340 may include an optional teleoperations arrangement 342 that enables vehicle 101 to be controlled by a teleoperator or a remote operator. Such an optional teleoperations arrangement 342 may generally enable communications between vehicle 101 and a teleoperations system.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

Sensor assembly 104 of sensor system 324 may generally include sensors such as a camera, a lidar, and a radar that may collect data or information that may be processed such that the environment around autonomous vehicle 101 may be relatively accurately perceived. With reference to FIGS. 4A and 4B, sensor assembly 104 will be discussed in accordance with an embodiment. FIG. 4A is a diagrammatic representation of sensor assembly 104 in accordance with an embodiment. Sensor assembly 104 includes a lidar 442, a plurality of cameras 446, and a radar arrangement 448. Cameras 446 may be part of a camera array that is arranged such that cameras 446 may cooperate to provide a relatively long range, approximately 360 degree view. In one embodiment, a camera array includes approximately nine cameras 446, although it should be understood that the number of cameras 446 in a camera array may vary widely. The camera array and, hence, cameras 446 may be positioned substantially over radar arrangement 448.

In general, sensor assembly 104 includes components which are not shown in FIG. 4A. FIG. 4B is a block diagram representation of sensor assembly 104 of in accordance with an embodiment. Sensor assembly 104 includes lidar 442, a camera array that includes cameras 445, and radar 448, as discussed above. In addition, sensor assembly 104 includes additional sensors 450 such as additional cameras and/or an inertial measurement unit (IMU). Such additional cameras may include, but are not limited to including, one or more traffic light cameras and short range cameras, e.g., cameras arranged to provide a short range view. A traffic light camera may be arranged to monitor and to detect traffic lights in front of a vehicle, and may provide a relatively wide-angle field of view. In one embodiment, a wide-angle field of view may be a view of greater than approximately sixty degrees.

In one embodiment, sensor assembly 104 is configured to clean and to clear sensors such as lidar 442 and cameras 446. A rotatable sensor housing 452 and sensor clearing and/or cleaning fans 454 are arranged to provide clearing and cleaning to lidar 442 and cameras 446. Cameras 446 may be positioned or housed behind rotatable sensor housing 452 or, behind a window surface of rotatable sensor housing 452. Sensor clearing and/or cleaning fans 454 may include airflow ducts, and may provide airflow to substantially clear debris and/or precipitation from sensor surfaces, e.g., surfaces of lidar 442 and cameras 446.

Sensor assembly 104 also includes a power arrangement 456 that is configured to obtain power from a power source, e.g., from a power system on vehicle 101 of FIGS. 2 and 3. Sensor assembly 104 also includes a communication arrangement 458 that enables sensor assembly to communicate, e.g., with systems on vehicle 101 of FIGS. 2 and 3. Data collected by sensor assembly 104 may be provided to systems on vehicle 101 of FIGS. 2 and 3 through communication arrangement 458.

Sensor assembly 104 is configured to collect data that relates to the surroundings of vehicle 101 of FIGS. 2 and 3 as vehicle 101 operates. The collected data is used by a perception system to facilitate autonomous operation. As such, the accuracy with which sensor assembly 104 operates has a substantially direct affect on the ability for an autonomy system perform safely.

To substantially ensure that data obtained from sensor assembly 104 is accurate, sensor assembly 104 may be tested or verified. A sensor testing system may enable sensor assembly 104 to be evaluated while off a vehicle. That is, a sensor testing system may be used to test, e.g., to calibrate or to otherwise assess, sensor assembly 104 prior to sensor assembly 104 being mounted on a vehicle.

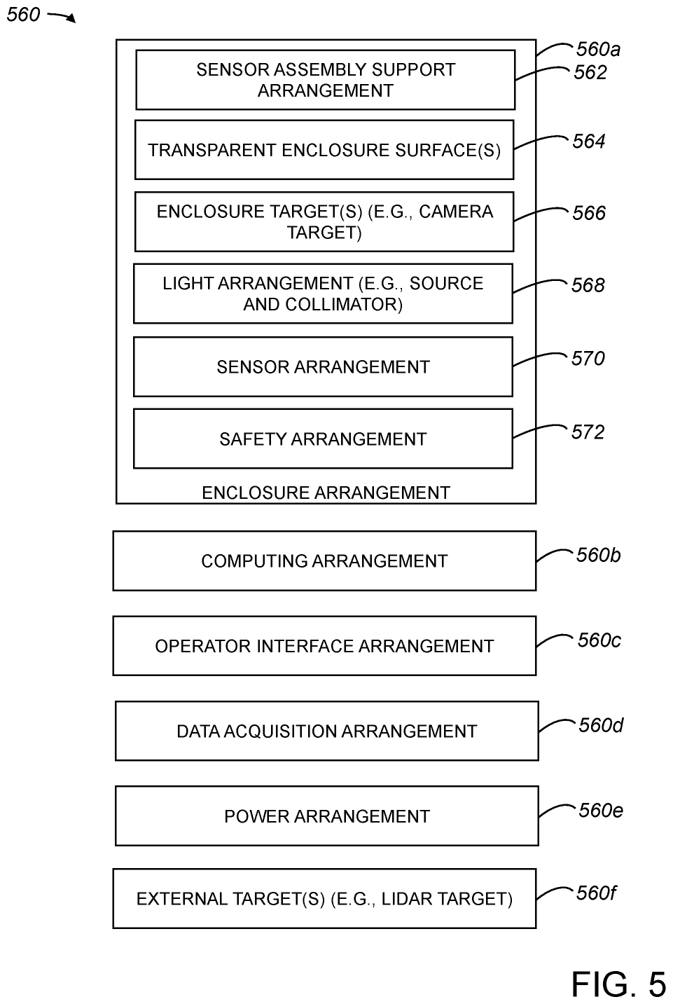

FIG. 5 is a block diagram representation of a sensor testing system in accordance with an embodiment. A sensor testing system 560 generally includes an enclosure arrangement 560a, a computing arrangement 560b, an operator interface arrangement 560c, a data acquisition arrangement 560d, a power arrangement 560e, and one or more external targets 560f.

Enclosure arrangement 560a is generally configured to contain, enclose, or house, a sensor assembly (not shown) during a testing process and enables the sensor assembly to be isolated from an outside environment, thereby allowing measurements relating to the sensor assembly to be made relatively accurately. For example, the accuracy with which sound measurements and/or vibration measurements may be made is enhanced. Enclosure arrangement 560a includes a sensor assembly support arrangement 562, one or more transparent enclosure surfaces 564, one or more enclosure targets 566, a light arrangement 568, a sensor arrangement 570, and a safety arrangement 572.

Sensor assembly support arrangement 562 may include a mechanical structure such as a platform configured to secure or to otherwise support a sensor assembly (not shown). Sensor assembly support arrangement 562 may also include one or more connectors which enable power to be provided to a sensor assembly (not shown) and/or enable data to be exchanged with the sensor assembly. In other words, sensor assembly support arrangement 562 may include connectors which allow a sensor assembly (not shown) to be electrically and communicatively coupled to sensor testing system 560. Sensor assembly support arrangement 562 may be moveable, e.g., capable of translating along an axis and/or rotating about an axis, and may also be arranged to be locked into one or more positions.

One or more transparent enclosure surfaces 564 are generally included as sides of enclosure arrangement 560a. Transparent enclosure surfaces 564 may be formed from any suitable material, e.g., polycarbonate or glass. Suitable materials generally provide a desired amount of strength and transparency. Transparent enclosure surfaces 564 allow for tests, as for example camera and/or lidar tests, to be performed using one or more external targets 560f. In general, transparent enclosure surfaces 564 also allow test operator to effectively observe a sensor assembly (not shown) during a testing process.

One or more enclosure targets 566 are calibration targets which are either positioned within, or substantially affixed on or attached to, enclosure arrangement 560a. Enclosure targets 566 may include, but are not limited to including, targets suitable for use with cameras. It should be appreciated that enclosure targets 566 may have unique markers and or patterns, and that different enclosure targets 566 may be intended for use with different cameras. In one embodiment, enclosure targets 566 may remain at fixed locations relative to sensor assembly support arrangement 562 and, hence, a sensor assembly (not shown) supported by sensor assembly support arrangement 562.

Light arrangement 568 may include a light source and a collimator. Light arrangement 568 may cooperate with enclosure targets 566 to perform testing of cameras associated with a sensor assembly (not shown) secured by sensor assembly support arrangement 562. The testing of cameras may include, but is not limited to including verify that the cameras are functional, e.g., capable of generating output images, and properly connected such that output from cameras is provided to an appropriate component of a sensor assembly (not shown). The use of enclosure targets 566 and light arrangement 568 may enable production errors, e.g., the incorrect connection of a camera to a port on a printed circuit board of a sensor assembly (not shown) to be identified and, thus, corrected.

Sensor arrangement 570 may generally includes sensors which are contained within enclosure arrangement 560a, and are used to obtain data relating to the operation of a sensor assembly (not shown) that is positioned and operating within enclosure arrangement 560a. Such sensors may include, but are not limited to including, vibration sensors, temperature sensors, airflow sensors, cameras, and/or sound sensors such as microphones.

Safety arrangement 572 may include one or more mechanisms configured to ensure the safe operation of a sensor assembly (not shown) housed in enclosure arrangement 560a. Safety arrangement 572 may include an alarm system that is configured to provide an alert when there is an issue with a sensor assembly (not shown). In one embodiment, safety arrangement 572 may include a safety interlock that locks an access door to enclosure arrangement 560a during a testing process. A safely interlock may prevent individuals, as for example operators, from accidentally touching a sensor assembly (not shown) that is powered on with a spinning or rotating housing. It should be appreciated that such a safety interlock may be substantially disabled or disengaged to allow loading and unloading of a sensor assembly (not shown) into enclosure arrangement 560a.

Computing arrangement 560b may in communication with sensor assembly support arrangement 562 and, thus, a sensor assembly (not shown) supported on sensor assembly support arrangement 562 to obtain information from sensors on the sensor assembly. In one embodiment, computing arrangement 560b may be arranged to replicate the systems of a vehicle such as vehicle 101. Computing arrangement 560b may include a main compute, a secondary compute, one or more switches such as ethernet switches, and a communications arrangement that are configured similarly to substantially equivalent systems in a vehicle such as vehicle 101.

Operator interface arrangement 560c is generally arranged to enable a test operator to interact with sensor testing system 560. Operating interface arrangement 560c may cause one or more commands to be provided from the computing arrangement 560b to sensor assembly support arrangement 562 that cause a sensor assembly (not shown) secured by sensor assembly support arrangement 562 to execute one or more tests. Data acquisition arrangement 560d is configured to obtain or receive, analyze, and log, data obtained from a sensor assembly (not shown) as a result of tests executed by sensor testing system 560 on the sensor assembly. Data acquisition arrangement 560d may process obtained data to effectively determine whether a testing process is considered to be successful or not. Power arrangement 560e generally includes a power supply and may include a current and voltage monitoring system.

One or more external targets 560f may be positioned outside of enclosure arrangement 560b. In one embodiment, external targets 560f include one or more lidar targets that enable a lidar included in a sensor assembly (not shown) supported on sensor assembly support structure 562 to be tested. A lidar target may be positioned at specific distances and/or angles relative to a sensor assembly (not shown) supported on sensor assembly support structure 562. The dimensions and/or angles may vary widely, and may depend upon the type of lidar that is being tested, e.g., a solid state lidar may be positioned at distances and or/angles which differ from those at which a rotational or spinning lidar may be positioned.

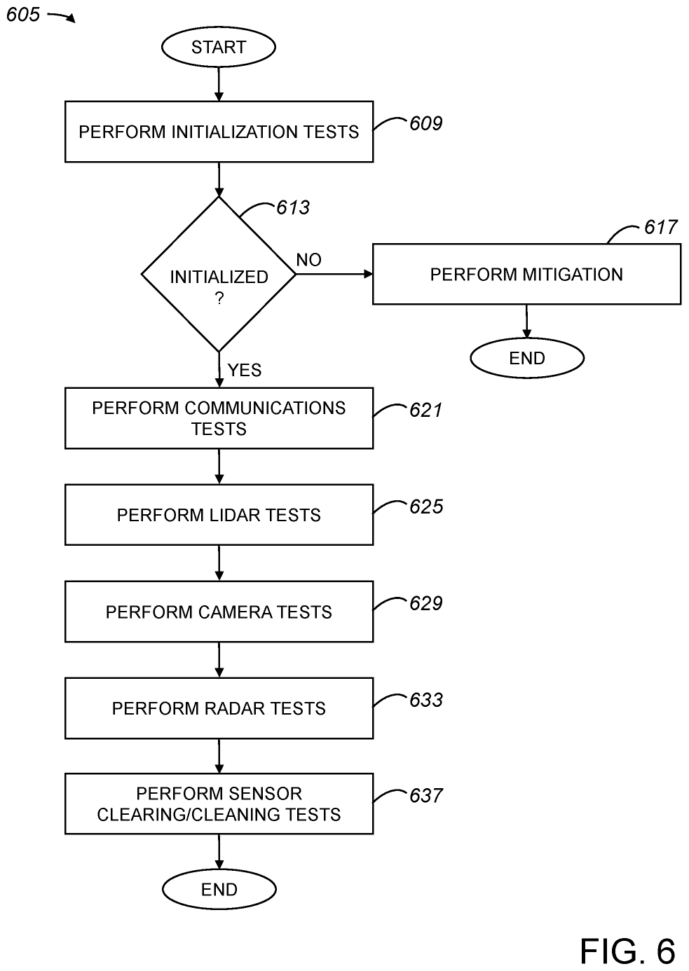

FIG. 6 is a process flow diagram which illustrates a method of using a sensor testing system to test a sensor assembly in accordance with an embodiment. A method 605 of using a sensor testing system begins at a step 605 in which initialization tests are run on a sensor assembly positioned in an enclosure of the sensor testing system. Initialization tests may generally include, but are not limited to including, tests which determine whether the sensors of a sensor assembly are receiving power and/or are able to collect data. It should be appreciated that the tests may vary widely, depending at least in part on the purpose or purposes that the sensor assembly is intended to fulfill.

In a step 613, a determination is made as to whether the sensor assembly has been successfully initialized. If the determination is that the sensor assembly has not been successfully initialized, the implication is that there is an issue such as a fault in the sensor assembly. As such, process flow moves from step 613 to a step 617 in which mitigation is performed on the sensor assembly. Mitigation may include, but is not limited to including, performing troubleshoot, identifying a source of an issue, fine tuning one or more components of the sensor assembly, and/or replacing one or more components of the sensor assembly. Upon performing mitigation, the method of using a sensor testing system is completed.

Alternatively, if it is determined in step 613 that the sensor assembly has been successfully initialized, then tests may be performed using the sensor testing system. From step 613, process flow moves to a step 621 in which communications tests are performed. Communications tests may be accomplished by the sensor testing system transmitting data to and receiving data from the sensor assembly such that communication capabilities of the sensor assembly may be tested, e.g., to determine a substantially maximum data throughput associated with communication arrangement 458 of FIG. 4B.

After the communications tests are performed, lidar tests are performed in a step 625 The lidar tests may include, but are not limited to including, activating a lidar unit and utilizing targets that are positioned external to an enclosure of the sensor testing system. One or targets may effectively be detected when beams generated by the lidar are substantially reflected off of the one or more targets. Data generated by the lidar may be verified to substantially ensure that there is no significant data corruption, as well as that a number of laser beams generated by the lidar may be verified.

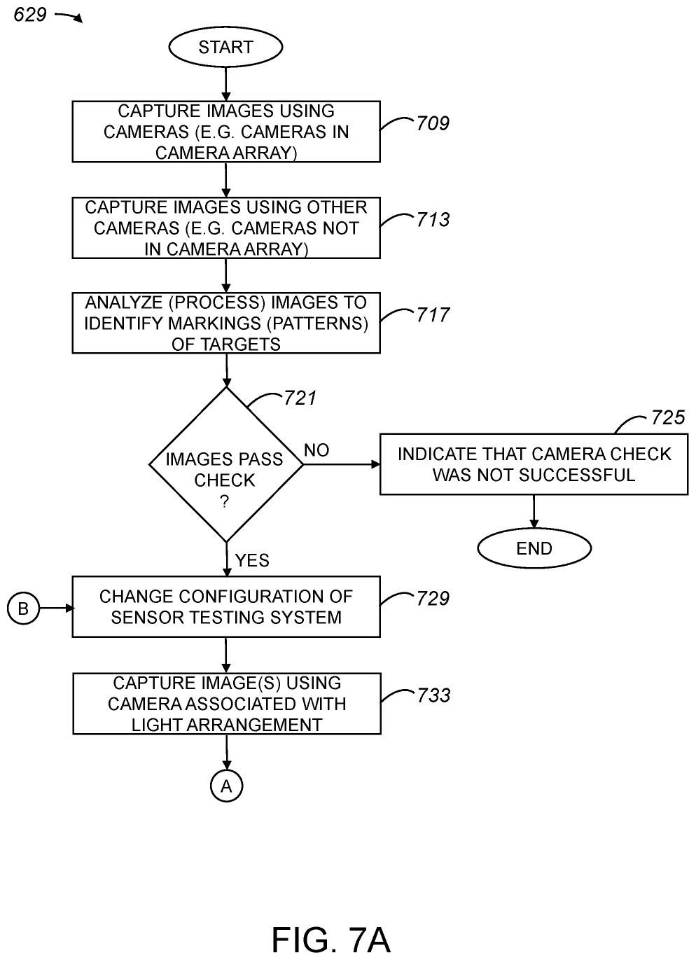

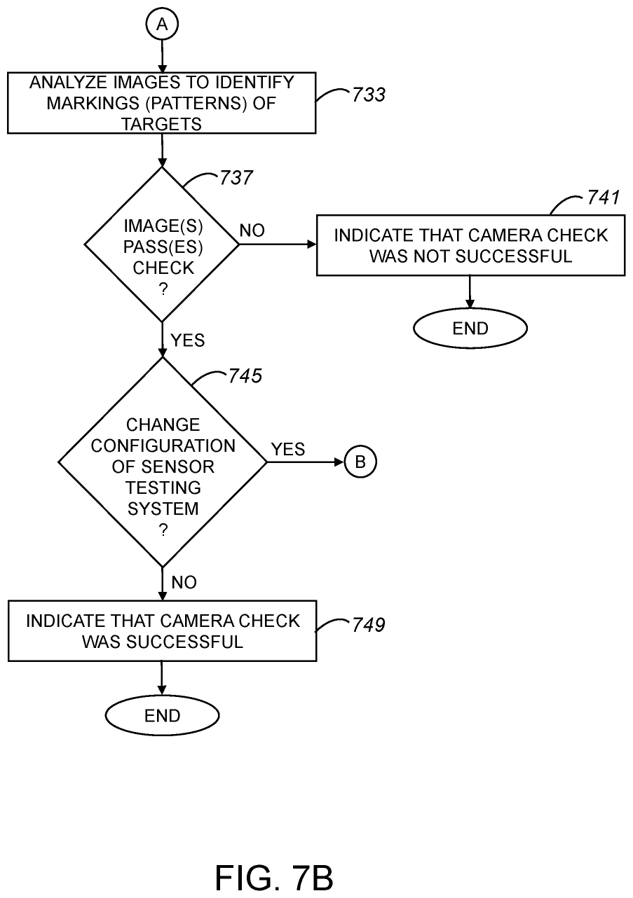

Once lidar tests are performed, camera tests are performed in a step 629. In general, long range cameras that are effectively part of a camera array of the sensor assembly, short range cameras, and/or a traffic light camera may be tested or evaluated. Steps associated with one method of performing camera tests will be discussed below with respect to FIGS. 7A and 7B.

After camera tests are performed, radar tests are performed in a step 633. Data generated by radar onboard the sensor assembly may be obtained and verified by the sensor testing system to effectively ensure that any data degradation is insignificant or otherwise acceptable.

In a step 637, sensor clearing and cleaning tests may be performed. The performance of sensor clearing and cleaning tests may include verifying that one or more fans included in a sensor clearing and cleaning arrangement are able to reach substantially maximum spin speeds within a prescribed amount of time, verifying that desired amounts of airflow may be achieved, and/or verifying that a rotatable window or shield of the sensor clearing and cleaning arrangement may reach a substantially maximum designed rate of rotation within a prescribed amount of time. Upon performing sensor clearing and cleaning tests, the method of using a sensor testing system to test a sensor assembly is completed.

As a sensor testing system tests a sensor assembly, various sensors included in the sensor testing system may be used to capture data or information which provides an indication of how the sensor assembly is operating. For example, temperature sensors may measure the temperature in an enclosure of the sensor testing system such that it may be determined whether the sensor assembly is overheating. In one embodiment, while a sensor clearing and cleaning mechanism is being tested, vibrations and sounds may be monitored within an enclosure such that it may be determined whether the levels and/or frequencies of vibrations, as well as the amount of sound, are within expected ranges. Unexpected levels and/or unexpected frequencies may be indicative of improper operation of the sensor clearing and cleaning mechanisms. The improper operation may, in turn, indicate potential issues that may cause damage to components of the sensor assembly and/or the sensor testing system.

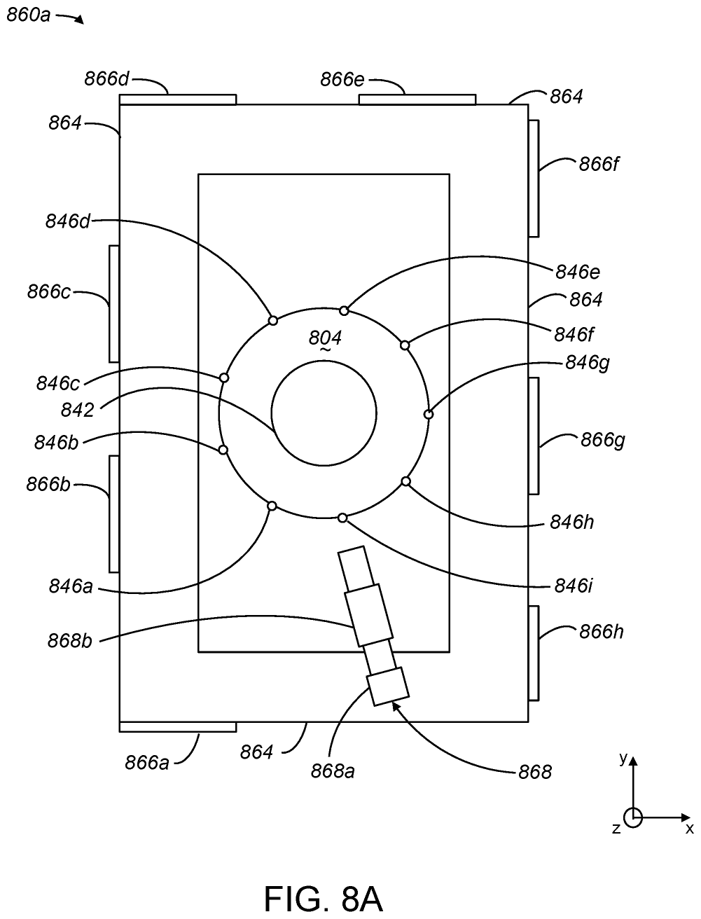

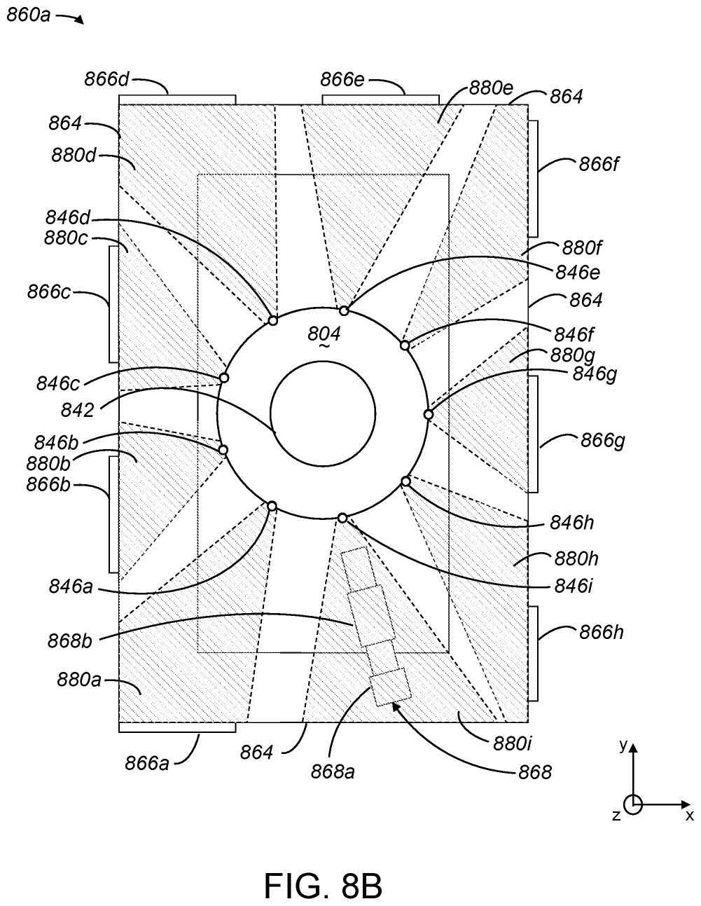

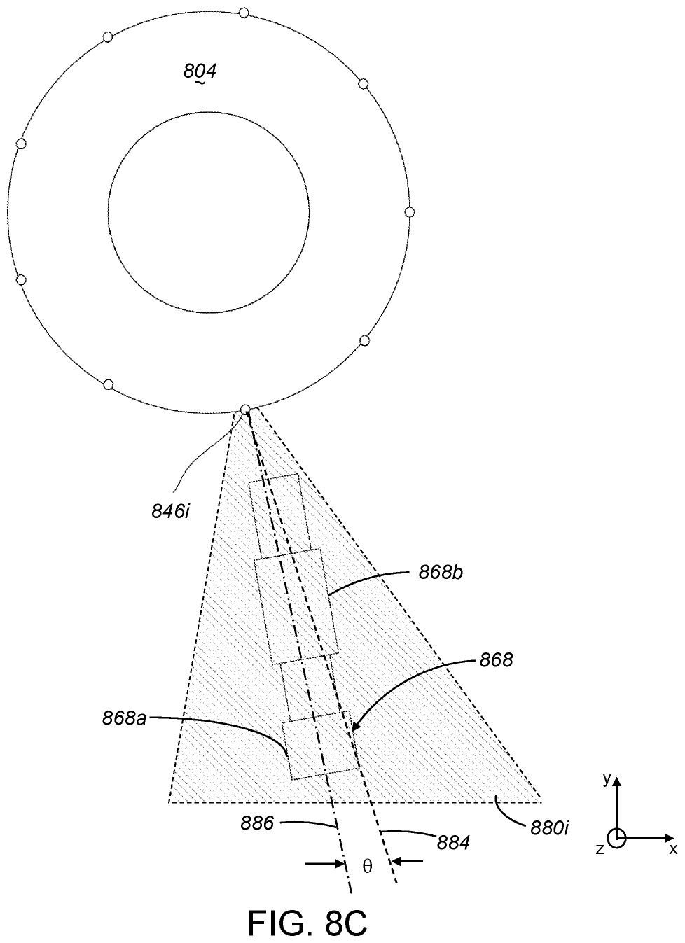

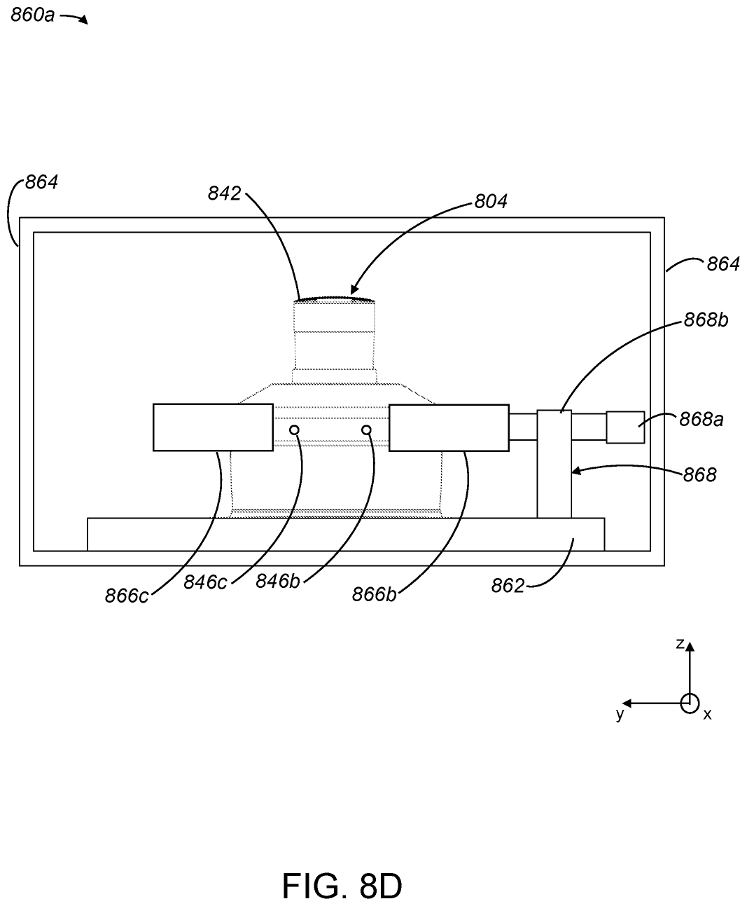

Referring next to FIG. 7, one method of performing camera tests on a sensor assembly using a sensor testing system, e.g., step 629 of FIG. 6, will be described in accordance with an embodiment. Method 629 of performing camera tests begins at a step 709 in which images are captured using long range cameras, or cameras that are part: of a camera array, e.g., cameras 446 of FIGS. 4A and 4B. The images may be captured by activating the cameras using the sensor testing system. The captured images may include, but are not limited to including, images of the markings or patterns on enclosure targets. The cameras that are part of a camera array may each be used to capture an image associated with a corresponding enclosure target, as will be discussed below with respect to FIGS. 8A-D. Each enclosure target may be substantially uniquely identifiable. As such, when images are analyzed or processed, it may be determined which cameras are operational and/or properly configured.

In a step 713, images are captured using other cameras. For example, images may be captured using cameras such as a traffic light camera or a short range camera that are arranged to operate substantially independently of cameras associated with a camera array. The traffic light camera may be a front-facing camera that is configured to monitor and to detect the presence of traffic lights in front of a vehicle. Images captured or taken by the traffic light camera may capture one or more enclosure targets.

Once images are captured, the images are analyzed to identify markings or patterns of the targets in a step 717. When markings or patterns of an image captured by, a particular camera are identifiable, the image may be considered to “pass” and, thus, the camera that capture the image may be considered to be operable and properly configured. Analyzing or processing the images may generally include identifying whether images have substantially captured the markings or patterns of the targets accurately, or to a predetermined level of accuracy, such that the markings or patterns are identifiable. By way of example, a pattern that a camera captures in an image may be compared to the actual pattern present on a corresponding target to determine if there is a match. A target may have a pattern with a specific number of lines, and if the image of the target captured by a camera includes a pattern with the specific number of lines, the camera may be considered to pass a test. It should be appreciated that an image which includes fewer lines or more lines than indicated in a pattern on a target typically indicates that a camera which captured the image dos not pass.

A determination is made in a step 721 as to whether the images are considered to pass a check, i.e., whether an analysis of the images indicate that the images pass. If the determination is that the images do not pass a check, the indication is that one or more cameras are not operational or not properly configured. As such, in a step 725, an indication that the camera check was not successful is created or otherwise set, and the method of performing a camera check is completed.

Alternatively, if it is determined in step 721 that the images pass a check, process flow proceeds to a step 729 in which the configuration of the sensor testing system is changed. In one embodiment, changing the configuration of the sensor testing system may involve rotating a rotatable sensor housing at a first speed. Typically, the cameras included in a camera array are positioned within the rotatable sensor housing. The spinning, rotating, or revolving of a rotatable sensor housing enables moisture, condensation, precipitation, cleaning fluid, dust, and/or other contamination or particles to be cleared and/or cleaned from the surface of the rotatable sensor housing. To cause the rotatable sensor housing to rotate at a particular speed or rate of rotation, one or more commands may be transmitted by the sensor testing system to the sensor assembly.

After the configuration of the sensor testing system is changed, one or more images may be captured in a step 733 using one or more cameras associated with a light arrangement of the sensor testing system. It should be understood that one or more cameras included in a sensor assembly, e.g., one or more of cameras 446 of FIGS. 4A and 4B, may be associated with a light arrangement, e.g., light arrangement 568 of FIG. 5 that includes a light source and a collimator. The use of a light arrangement may essentially ensure that test procedures are functional after the configuration of the sensor testing system is changed. That is, the light arrangement, and the alignment of the light arrangement, may effectively be calibrated after the configuration of the sensor testing system is changed.

From step 733, process flow proceeds to a step 737 in which the captured images are analyzed to identify markings or patterns of targets. The effects of the rotation of the rotatable sensor housing may affect the quality of the image captured by the one or more cameras. In one embodiment, a spectral frequency response (SFR) may be determined fir the one or more captured images, and the determined SFR may be compared against a predefined threshold limit. By way of example, the SFR for a first image captured while the rotatable sensor housing is rotating at a first rate of rotation may be compared against a first SFR threshold value that is associated with the first rate of rotation. In another embodiment, SFR values may be computed such that an SFR delta, e.g., a difference between a first SFR value associated with a first rate of rotation of a rotatable sensor housing and a second SFR value associated with a second rate of rotation of the rotatable sensor housing, may be determined and compared against an associated threshold value.

In a step 737, it is determined ether the one or more images pass a check. If the determination is that the one or more images does not pass a check, as for example if an SFR value does not compare favorably against a threshold value, then the camera check is indicated to not be successful in a step 741, and the method of performing a camera test is completed.

Alternatively, if the determination in step 737 is that the one or more images pass a check, then it is determined in a step 745 whether the configuration of the sensor testing system is to be changed. In one embodiment, determining whether the configuration of the sensor testing system is to be changed includes determining whether to change, e.g., increase or decrease, the rotational rate of the rotatable sensor housing. If it is determined that the configuration of the sensor testing system is to be changed, then process flow proceeds to step 729 in which the configuration of the sensor testing system is changed. On the other hand, if it is determined in step 745 that the configuration of the sensor testing system is not to be changed, the indication is that the camera test has been successfully completed. As such, in a step 749, an indication is created to indicate that a camera check was successful, and the method of performing a camera check is completed.

With reference to FIGS. 8A-D, an enclosure of a sensor testing system with a sensor assembly housed or otherwise secured within the sensor testing system will be described in accordance with an embodiment. An enclosure 860a of a sensor testing system includes enclosure walls 864 within which a sensor assembly 804 that includes a lidar 842 and a plurality of cameras 846a-i that form an array is positioned. Sensor assembly 804 may be supported on a structure 862. Enclosure 860a also includes enclosure targets 866a-h which have markings or patterns, and a light arrangement 868 that includes a light source 868a and a collimator 868b. It should be appreciated that the number of cameras 846a-i and the number of enclosure targets 866a-h may vary. In addition, the placement of enclosure targets 866a-h may also vary.

Enclosure walls 864 may be transparent, and enclosure targets 866a-h may be affixed to enclosure walls 864, e.g., on exterior surfaces of enclosure walls 864. It should be appreciated, however, that enclosure targets 866a-h may alternatively be affixed to interior surfaces of enclosure walls 864.

Cameras 846a-i onboard sensor assembly 804 are configured to provide a substantially 360 degree view of an environment of a vehicle when sensor assembly 804 is installed on the vehicle. One or more of cameras 846a-i may be tested using enclosure targets 866a-h. By way of example, cameras 846a-h may be tested using camera targets 866a-h, respectively. As shown in FIG. 8B, each camera 846a-i has an associated field of view 880a-i. As will be appreciated by those skilled in the art, fields of view 880a-i may have components along an x-axis, a y-axis, and a z-axis. Enclosure targets 866a-h may be positioned on enclosure walls 864 such that during the testing of sensor assembly 880, enclosure targets 866a-h may each be within fields of view 880a-h of cameras 846a-h, respectively. By way of example, camera 846a may have field of view 880a that encompasses enclosure target 866a when sensor assembly 804 is positioned within enclosure 860a, thereby effectively enabling camera 846a to be tested using enclosure target 866a.

The substantially unique markings or patterns on enclosure targets 866a-h also facilitate the determination of a resolution to correct any issues or defects identified through testing. For example, by determining which target 866a-h each camera 846a-h captured during a test, a determination may be made as to whether any camera 846a-h is incorrectly wired and/or incorrectly connected.

In one embodiment, light arrangement 868 may be a target for at least one camera 846a-i. Light arrangement 868, as shown, is in a field of view 880i for camera 846i. As such, camera 846i may be tested using light source 868a, which may be an LED light source configured to generate light, and collimator 868b, which may be configured to collimate light generated by light source 868a and to direct collimated light to camera 846i. It should be understood that in some instances, collimator 868b may be configured to collimate light generated by light source 868a and direct collimated light to camera 846i such that light source 868a essentially appears to be at a relatively far distance away from camera 846i.

Output or an image captured by camera 846i from light arrangement 868 may be analyzed to ascertain whether the output is as expected. Light arrangement 868 may also be used to substantially test the optical performance of a rotatable sensor housing (not shown). Imperfections, e.g., contaminants, on the rotatable sensor housing (not shown) and deviations in the rotation of the rotatable sensor housing may have an adverse effect on the image quality associated with images captured by cameras 846a-i. By way of example, the output of camera 846i capturing light generated by light source 868a and collimated by collimator 868b may be used to substantially verify the optical performance of a rotatable sensor sousing (not shown). The rotatable sensor housing (not shown) may be configured to rotate at different rotational rates and SFRs of the outputs of camera 846i generated at the various rotational rates may be determined as measures of the optical performance of the rotatable sensor housing.

As shown in FIG. 8C, light source 868a and collimator 868b may be positioned at an angle θ with respect to a center line 884 that effectively represents a center of field of view 880i associated with camera 856i and a center line 886 of light arrangement 868. Light arrangement 868 may be positioned substantially off-center with respect to center line 884 at angle θ because SFR is typically more sensitive at an off-axis that at an on-axis due, for example, to defects in transparent surfaces such as windows. Angle θ may vary widely. In one embodiment, angle θ may be between approximately five degrees and approximately twenty-five degrees, as for example between approximately ten degrees and approximately twenty degrees.

Each enclosure target 866a-h may have a substantially unique identifying marking or pattern. When cameras 846a-h are tested, images captured or generated by a particular camera 846a-h may be analyzed to determine whether the captured image substantially matches the substantially unique identifying marking or pattern of the corresponding enclosure target 866a-h. For example, in the event that the image captured by camera 846a does not substantially match the marking or patterns of enclosure target 866a, camera 846a may be identified as having an issue, or malfunctioning.

In one embodiment, sensor assembly 804 may include a traffic light camera (not shown) that has a wider field of view than cameras 846a-I, and may capture images that include two or more enclosure targets 866a-h. A traffic light camera (not shown) may be a front-facing camera configured to face forward on a vehicle (not shown) and may, for example, capture images of enclosure targets 866f, 866g, and 866h.

In general, conditions within an enclosure of a sensor testing system may be monitored to determine whether a sensor assembly that is undergoing testing potentially has an issue, e.g., is not operating as expected. Sensors in the enclosure, or sensors included in a sensor testing system, may facilitate diagnosing issues that may not generally be diagnosed by sensors included in a sensor assembly. For instance, if the sensor assembly is emitting excessive noise or sound, or if the sensor assembly is vibrating, sensors included in the sensor testing system may identify the presence of excessive noise or sound, and/or excessive vibration.

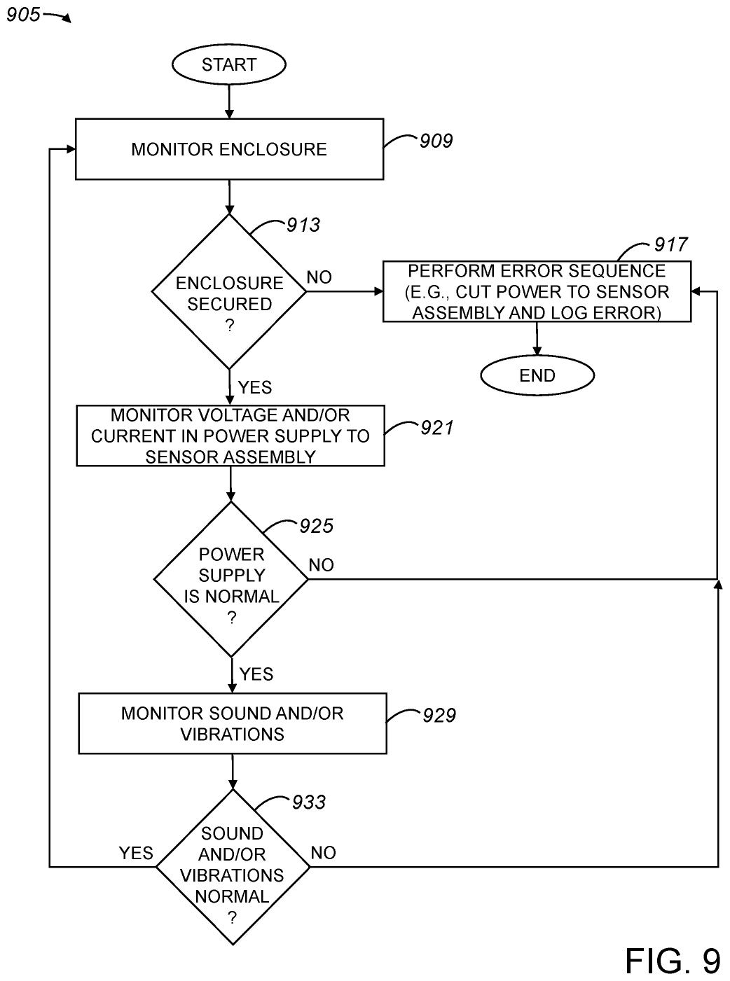

FIG. 9 is a process flow diagram which illustrates a method of monitoring testing performed on a sensor assembly using a sensor testing system in accordance with an embodiment. A method 905 of monitoring testing performed or otherwise run on a sensor assembly using a sensor testing system begins at a step 909 in which an enclosure of the sensor testing system is monitored. The sensor testing system may be monitored by processing data provided by various systems and sensors included in the sensor testing system. In one embodiment, monitoring the enclosure may involve determining whether the enclosure is secure, e.g., if a locking or safety arrangement of the enclosure is closed and/or locked.

In a step 913, it is determined whether the enclosure is secured. If the enclosure is not secured, an operator of the sensor testing system may be endangered, and the sensor assembly may potentially be damaged. It should be appreciated that sensors included in an enclosure may include a camera which enables an operator to essentially view the sensor assembly and the enclosure a test is run. Determining whether the enclosure is secured may include, but is not limited to including, obtaining data from sensors which are configured to sense when the enclosure is closed and/or locked, analyzing an image provided by a camera within the enclosure.

If the determination is that the enclosure is not secured, then process flow proceeds to a step 917 in which an error sequence is performed. That is, steps are taken in response to the detected issue, e.g., the enclosure not being closed or locked, to substantially mitigate any safety risk associated with an unsecured enclosure. Such steps may include, but are not limited to including, cutting or otherwise termination power supplied to the sensor assembly, logging the issue or error, and/or terminating the testing of the sensory assembly. Upon performing an error sequence, the method of monitoring testing is completed.

Alternatively, if it is determined in step 913 that the enclosure is secured, then in a step 921, the voltage and/or current provided to the sensor assembly by a power supply may be monitored. A determination is made in a step 925 to determine whether the power supply is functioning normally, or as expected. For example, it may be determined whether sufficient, insufficient, or excessive amounts of voltage and/or current is provided by the power supply. In the event that the sensor assembly is drawing excessive amounts of power or insufficient amounts of power, the indication is generally that the sensor assembly may have an issue, e.g., a component of the sensor assembly may have a fault.

If the determination in step 925 is that the power supply is not functioning normally, then process flow proceeds to step 917 in which an error sequence is performed. Alternatively, if it is determined that the power supply is functioning normally, sensors in the enclosure are used to monitor sound and/or vibrations associated with the sensor assembly in a step 929.

A determination is made in a step 933 as to whether sounds and/or vibrations emitted by the sensor assembly, and detected by sensors included in the sensor testing system, are as expected. If it is determined that there is a substantially abnormal amount of sound and/or vibrations detected, then the implication is that the sensor assembly has an issued. As such, process flow proceeds to step 917 in which an error sequence is performed.

If, however, it is determined in step 933 that the amount of sound and or vibrations is substantially normal, the indication is that the sensor assembly does not have an issue. Accordingly, process flow returns to step 909 in which the enclosure continues to be monitored.

A tested or verified sensor assembly is typically mounted on a vehicle, and may be tested after being mounted on the vehicle as part of an overall test to determine whether the vehicle is ready for use, e.g., deployment.

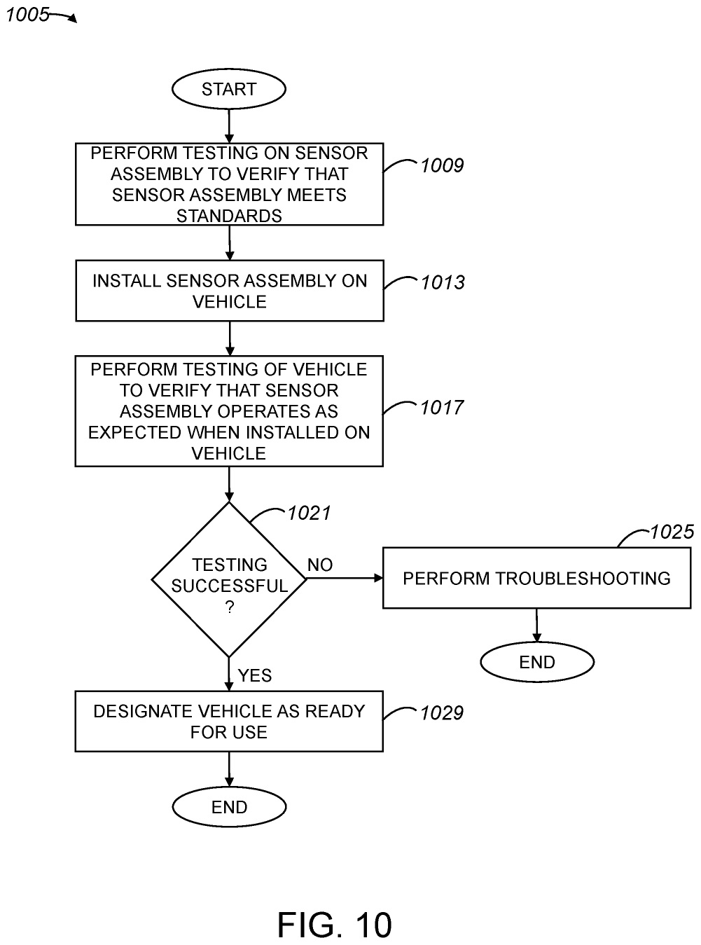

FIG. 10 is a process flow diagram which illustrates a method of identifying a vehicle that includes a sensor assembly tested using a sensor testing system as being ready for use in accordance with an embodiment. A method 1005 of identifying a vehicle as being ready for use begins at a step 1009 in which testing is performed on a sensor assembly, e.g., sensor assembly 104 of FIGS. 4A and 4B, to verify that the sensor assembly meets standards, e.g., capable of performing at an expected level.

Once the sensor assembly is verified as meeting standards, the sensor assembly is installed on a vehicle in a step 1013. Installing the sensor assembly on the vehicle generally includes, but is not limited to including, physically securing the sensor assembly to the vehicle, electrically coupling the sensor assembly to the vehicle, and communicably coupling the sensor assembly to the vehicle.

After the sensor assembly is installed on the vehicle, the vehicle is comprehensively tested to verify that the vehicle meets standards in a step 1017. The comprehensive testing generally includes verifying that the sensor assembly operates as expected when installed on the vehicle.

In a step 1021, a determination is made as to whether the testing of the vehicle was successful. If the determination is that the testing was successful, the vehicle is designated as ready for use in a step 1029, and the method of identifying a vehicle as being ready for use is completed. Alternatively, if the determination is that the testing was not successful, the indication is that there is an issue with the sensor assembly. As such, process flow moves from step 1021 to a step 1025 in which troubleshooting is performed to identify why the testing was not successful, and the method of identifying a vehicle as being ready for use is terminated.

Although only a few embodiments have been described in this disclosure, it should be understood that the disclosure may be embodied in many other specific forms without departing from the spirit or the scope of the present disclosure. By way of example, any suitable sensor assembly may be tested or verified using a sensor testing system. That is, the sensor assembly described above is an example of a sensor assembly which may be tested using a sensor testing system, and the sensor testing system described is not limited to being used for testing the sensor assembly described above.

The testing process described above may be part of an overall comprehensive testing process performed on a sensor assembly. That is, the sensor assembly test described above may be one of many tests performed on a sensor assembly to determine whether the sensor assembly meets operational standards.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. By way of example, the order in which sensors on a sensor assembly are tested may vary. Therefore, the present examples are to be considered as illustrative and not restrictive, and the examples are not to be limited to the details given herein, but may be modified within the scope of the appended claims.

What is claimed is:

1. A method comprising:
obtaining a sensor assembly, the sensor assembly including a plurality of cameras including at least a first camera and a second camera;
positioning the sensor assembly in an enclosure of a sensor testing system, the enclosure having a plurality of enclosure targets affixed thereon, the plurality of enclosure targets including a first enclosure target and a second enclosure target, wherein the enclosure includes a sensor arrangement and wherein the sensor testing assembly further includes a computing arrangement and a data acquisition arrangement;
performing a first test on the sensor assembly, wherein performing the first test on the sensor assembly include providing commands to the sensor assembly using the computing arrangement;
monitoring the sensor assembly during the first test, wherein monitoring the sensor assembly includes obtaining data from at least one selected from a group including the sensor assembly and the sensor arrangement and providing the data to the data acquisition arrangement; and
processing the data, wherein processing the data includes determining whether the data indicates that the sensor assembly passes the first test.

2. The method of claim 1 wherein the first test includes a camera test, and wherein performing the first test includes capturing a first image of the first enclosure target using the first camera and capturing a second image of the second enclosure target using the second camera.

3. The method of claim 2 wherein the first enclosure target includes a first pattern and the second enclosure target includes a second target, and wherein processing the data includes determining whether the first image captures the first pattern such that the first pattern is identifiable and determining whether the second image captures the second pattern such that the second pattern is identifiable.

4. The method of claim 3 wherein when it is determined that the first image captures the first pattern such that the first pattern is identifiable and when it is determined that the second image captures the second pattern such that the second pattern is identifiable, the sensor assembly passes the first test.

5. The method of claim 1 wherein the sensor arrangement includes a sound sensor, the sound sensor being arranged to collect data associated with a sound generated during the first test and to provide the data associated with the sound to the data acquisition arrangement, wherein monitoring the sensor assembly during the first test includes collecting the data associated with the sound generated during the first test.

6. The method of claim 1 wherein the sensor arrangement includes a vibration sensor, the vibration sensor being arranged to collect data associated with a vibration generated during the first test and to provide the data associated with the vibration to the data acquisition arrangement, wherein monitoring the sensor assembly during the first test includes collecting the data associated with the vibration generated during the first test.

7. The method of claim 1 wherein the plurality of cameras includes a third camera, and wherein the enclosure includes a light source configured to generate light and a light collimator configured to collimate the light, wherein the third camera is arranged to capture a third image of the collimated light.

8. The method of claim 1 wherein the sensor assembly includes a lidar and the sensor testing system includes a lidar target, the lidar target being external to the enclosure, and wherein the first test includes activating the lidar and collecting data using the lidar and the lidar target.

9. Logic encoded in one or more tangible non-transitory, computer-readable media for execution and when executed operable to:
perform a first test on a sensor assembly positioned within an enclosure included in a sensor testing system, the sensor assembly including at least a first camera and a second camera, the sensor testing system further including a sensor arrangement positioned in the enclosure, the enclosure having a first enclosure target affixed thereon and a second enclosure target affixed thereon, wherein the logic operable to perform the first test on the sensor assembly includes logic operable to provide commands to the sensor assembly using the computing arrangement;
monitor the sensor assembly during the first test, wherein the logic operable to monitor the sensor assembly includes logic operable to obtain data from at least one selected from a group including the sensor assembly and the sensor arrangement; and
process the data, wherein the logic operable to process the data includes logic operable to determine whether the data indicates that the sensor assembly passes the first test.

10. The logic of claim 9 wherein the first test includes a camera test, and wherein the logic operable to perform the first test includes logic operable to capture a first image of the first enclosure target using the first camera and logic operable to capture a second image of the second enclosure target using the second camera.

11. The logic of claim 10 wherein the first enclosure target includes a first pattern and the second enclosure target includes a second target, and wherein the logic operable to process the data includes logic operable to determine whether the first image captures the first pattern such that the first pattern is identifiable and logic operable to determine whether the second image captures the second pattern such that the second pattern is identifiable.

12. The logic of claim 11 wherein when it is determined that the first image captures the first pattern such that the first pattern is identifiable and when it is determined that the second image captures the second pattern such that the second pattern is identifiable, the sensor assembly passes the first test.

13. The logic of claim 9 wherein the sensor arrangement includes a sound sensor, the sound sensor being arranged to collect data associated with a sound generated during the first test and to provide the data associated with the sound to the data acquisition arrangement, wherein to logic operable to monitor the sensor assembly during the first test includes logic operable to collect the data associated with the sound generated during the first test.

14. The logic of claim 9 wherein the sensor arrangement includes a vibration sensor, the vibration sensor being arranged to collect data associated with a vibration generated during the first test and to provide the data associated with the vibration to the data acquisition arrangement, wherein the logic operable to monitor the sensor assembly during the first test includes logic operable to collect the data associated with the vibration generated during the first test.

15. An apparatus comprising:
an enclosure arrangement, the enclosure arrangement including a plurality of transparent enclosure surfaces, a plurality of enclosure targets affixed to the plurality of transparent enclosure surfaces, a sensor arrangement, and a sensor assembly support arrangement, wherein the sensor arrangement is configured to obtain information within the enclosure and the sensor assembly support arrangement is configured to support a sensor assembly;
a computing arrangement configured to communicate with the sensor assembly support arrangement;
a data acquisition arrangement configured to obtain data from the computing arrangement when the computing arrangement communicates with the sensor assembly support arrangement and to obtain data from the sensor arrangement; and
a power arrangement, the power arrangement configured to provide power to the sensor assembly support arrangement.

16. The apparatus of claim 15 wherein the plurality to enclosure targets includes a first camera target having a first pattern and a second camera target having a second pattern, and wherein the apparatus further includes a lidar target, the lidar target being positioned external to the enclosure.

17. The apparatus of claim 15 wherein the enclosure arrangement further includes a light arrangement, the light arrangement having at least a light source and a collimator, and wherein the sensor arrangement includes a sound sensor arranged to detect sound within the enclosure and a vibration sensor arranged to detect a vibration within the enclosure arrangement.

18. The apparatus of claim 17 wherein the data acquisition arrangement is configured to process the data obtained from the computing arrangement and the data obtained from the sensor arrangement, and wherein the data includes data obtained from the sound sensor and data obtained from the vibration sensor.

19. The apparatus of claim 18 wherein the computing arrangement is configured to communicate with the sensor assembly support arrangement to cause a test to be run, and wherein data acquisition arrangement is configured to process the data to determine whether the test is successful.

20. The apparatus of claim 19 wherein the sensor assembly support arrangement supports a sensor assembly including a first camera, a second camera, and a lidar, and wherein the test includes capturing images of the plurality of enclosure targets using the first camera and the second camera, the test further including capturing an image associated with the lidar target using the lidar.
